(19) United States
(12) Patent Application Publication
(10) Pub. No.: US 2023/0393582 A1
(43) Pub. Date: Dec. 7, 2023

(54) SIMULATED RESULTS-BASED MATERIAL MOVEMENT AT INDUSTRIAL AREA

(71) Applicant: INTERNATIONAL BUSINESS MACHINES CORPORATION, ARMONK, NY (US)

(72) Inventors: Saraswathi Sailaja Perumalla, Visakhapatnam (IN); Sarbajit K. Rakshit, Kolkata (IN); Venkata Ratnam Alubelli, Visakhapatnam (IN)

(21) Appl. No.: 17/805,600

(22) Filed: Jun. 6, 2022

(51) Int. Cl. G05D 1/02

(52) U.S. Cl. CPC G05D 1/0219; G05D 1/0214; G05D 1/0274; G05D 2201/0216

(57) ABSTRACT

A method, computer system, and a computer program product for material movement planning are provided. A computer receives a first notification of dimensions of a first material to be transported, a second notification of stowage positions of a first vehicle, a third notification of a pickup location and a drop-off location for the first material, and a fourth notification of space requirements of machines along a transport path. The computer generates a material movement plan for stowing the material on the first vehicle and for transporting the material along the transport path. The material movement plan is based on the dimensions of the material, the stowage positions of the first vehicle, the transport path, and the space requirements for the machines. The computer transmits the material movement plan for loading the first material into one of the stowage positions on the first vehicle according to the material movement plan.

### BACKGROUND

The present invention relates generally to a system and method for assisting automated handling and transport of material in a work environment such as a factory or a warehouse.

Automated guided vehicles have been used to transport goods and workpieces in warehouses that may also include factory assembly lines, factory assembly stations, and/or machine shopfloors with an industrial floor. Such environments may experience dynamic changes regarding how the various warehouse machines and components are being used. These changes result in challenges for automated guided vehicles that are seeking to navigate and transport items through the environment.

### SUMMARY

According to one exemplary embodiment, a method for material movement planning is provided. A computer receives a first notification of dimensions of a first material to be transported, a second notification of stowage positions of a first vehicle, a third notification of a pickup location and a drop-off location for the first material, and a fourth notification of space requirements of machines along a transport path. The computer generates a material movement plan for stowing the first material on the first vehicle and for transporting the first material along the transport path. The material movement plan is based on the dimensions of the first material, the stowage positions of the first vehicle, the transport path, and the space requirements for the machines. The computer transmits the material movement plan for loading the first material into one of the stowage positions on the first vehicle according to the material movement plan. A computer system and a computer program product corresponding to the above method are also provided.

### BRIEF DESCRIPTION OF THE DRAWINGS

These and other objects, features, and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1A illustrates a top view of an industrial floor environment in a reduced-space configuration for an automated guided vehicle according to at least one embodiment;

FIG. 1B illustrates a top view of an industrial floor environment in an expanded space configuration for an automated guided vehicle according to at least one embodiment;

FIG. 2A illustrates a side view of an automated guided vehicle and a material to be loaded onto the automated guided vehicle in a first stowage position according to at least one embodiment;

FIG. 2B illustrates the side view of the automated guided vehicle shown in FIG. 2A with the material of FIG. 2A having been loaded in the first stowage position according to at least one embodiment;

FIG. 2C illustrates the side view of the automated guided vehicle shown in FIG. 2A with the material of FIG. 2A having been loaded in a second stowage position according to at least one embodiment;

FIG. 3 illustrates a networked computer environment according to at least one embodiment;

FIG. 4 is an operational flowchart illustrating a material movement planning process according to at least one embodiment;

FIG. 5 is a block diagram of internal and external components of computers and servers depicted in FIGS. 1A, 1B, 2A, 2B, 2C, and 3 according to at least one embodiment;

FIG. 6 is a block diagram of an illustrative cloud computing environment including the computers depicted in FIGS. 1A, 1B, 2A, 2B, 2C, and 3 in accordance with an embodiment of the present disclosure; and

FIG. 7 is a block diagram of functional layers of the illustrative cloud computing environment of FIG. 6, in accordance with an embodiment of the present disclosure.

### DETAILED DESCRIPTION

Detailed embodiments of the claimed structures and methods are disclosed herein; however, it can be understood that the disclosed embodiments are merely illustrative of the claimed structures and methods that may be embodied in various forms. This invention may be embodied in many different forms and should not be construed as limited to the exemplary embodiments set forth herein. Rather, these exemplary embodiments are provided so that this disclosure will be thorough and complete and will fully convey the scope of this invention to those skilled in the art. In the description, details of well-known features and techniques may be omitted to avoid unnecessarily obscuring the presented embodiments.

The following described exemplary embodiments provide a method, computer system, computer program product, and material movement system for allowing automated guided vehicles to travel safely and efficiently through an industrial floor environment. In such an environment, different types of objects, machines, vehicles, cranes, tracks, etc. may be used for material handling and transporting. The vehicles may include automated guided vehicles as well as manually driven vehicles such as a forklift and/or a truck. In some instances, the dimensions of the materials that are being transported are larger than the vehicles on which the materials are loaded. In general, the vehicles that are transporting materials follow a path inside an industrial floor environment. Sufficient navigation space is required for the automated guided vehicles to travel through the industrial floor. The navigation space that is required depends on dimensions and shapes of the vehicle and of the transported materials as well as on a material-specific risk factor of material handling. Machines and other mobile robotic systems may also occupy the industrial floor space when an automated guided vehicle is undertaking a material transport assignment. A need is present for safe and efficient designs and component communication to provide safe and fast material transport within, out of, and/or into this working environment. The present embodiments harness power of machine learning models to take many input variables and, in response, output a plan for safe and fast material movement in this environment, especially for automated vehicles which perform transport assignments in this environment.

The present disclosure refers to automated guided vehicles which may include automated mobile robots (“AVRs”). The automated guided vehicle will include a body which may have one or more stowage positions for carrying and transporting goods. The automated guided vehicle may include one or more wheels rotatable via an axle. The AGVs may travel by following along marked long lines or wires on the floor and/or may use radio waves, vision cameras, magnets, and/or lasers for navigation. The AGVs may in some embodiments tow objects behind them in trailers and may autonomously attach to the trailers. The trailers can be used to move raw materials or finished product. The AGV may in some embodiments include a bed for storing and transporting objects thereon. The objects may be loaded onto the AGV in an automated manner by placing the objects/goods/materials on a set of motorized conveyor rollers. The objects may be unloaded from the AGV by reversing a direction of rotation of the motorized conveyor rollers. Laser guided vehicles and automated guided carts guided by magnetic tape are other examples of an automated guided vehicle according to the present embodiments. The automated guided vehicles may have completely-internal guide systems or may rely on extra infrastructure in the warehouse environment such as magnetic strips or visual markers to achieve navigation.

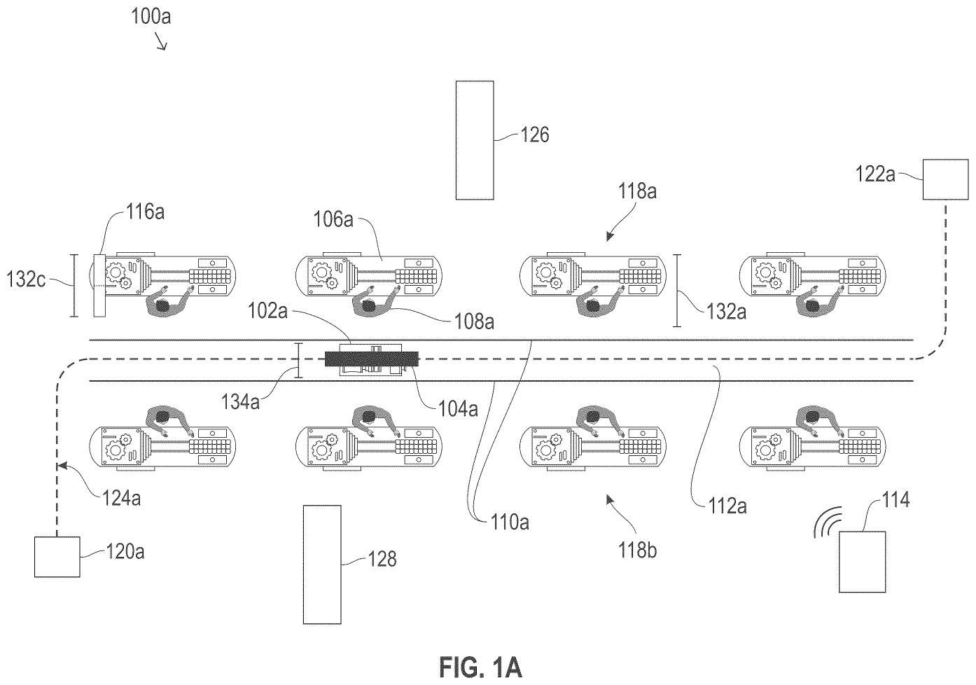

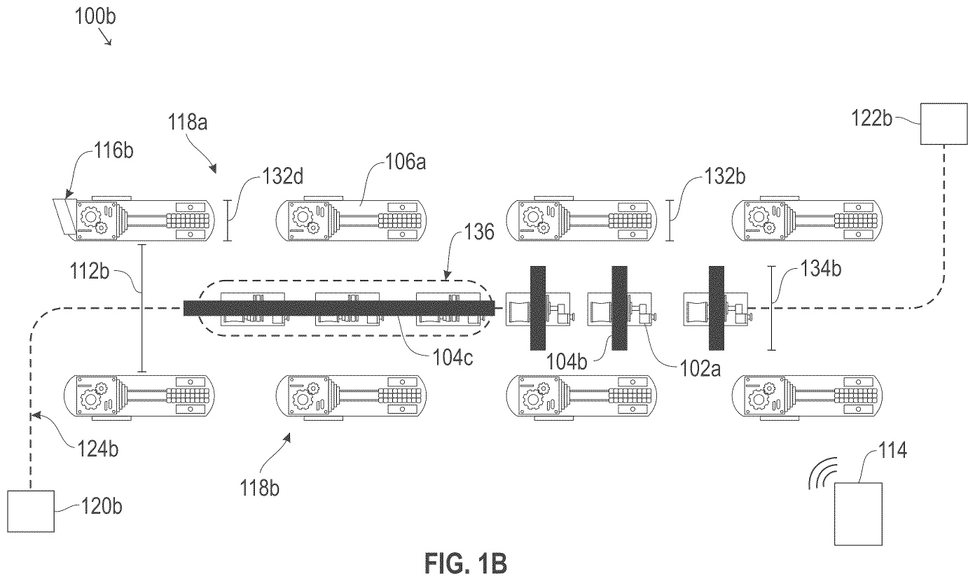

Referring to FIG. 1A, a crowded industrial floor environment 100a in accordance with an exemplary embodiment is depicted. The crowded industrial floor environment 100a may include a warehouse, one or more assembly lines, and/or one or more assembly stations. Machines such as the first machine 106a may be present in the crowded industrial floor environment 100a. The machines may be used to perform assembly, repair, packaging, and/or another step. A human worker such as the first human worker 108a may be positioned at a respective one of the machines, in this instance the first machine 106a, in order to perform or assist in performing the task. In some embodiments, the machines including the first machine 106a cut metal. In this depicted embodiment, the machines may be organized into rows such as a first row 118a and a second row 118b.

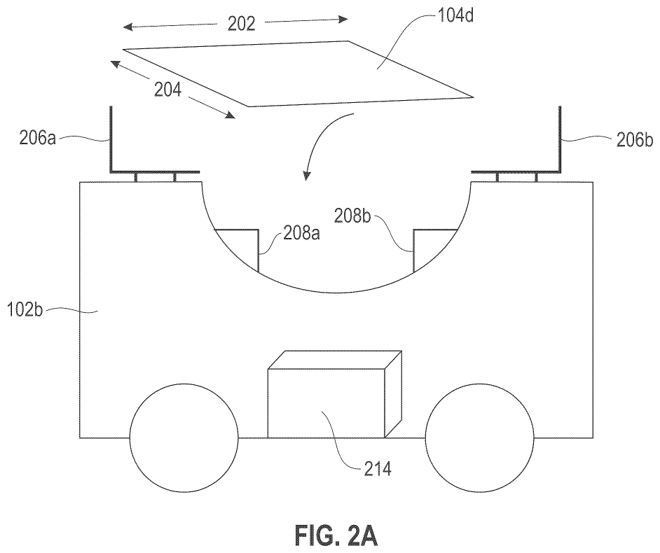

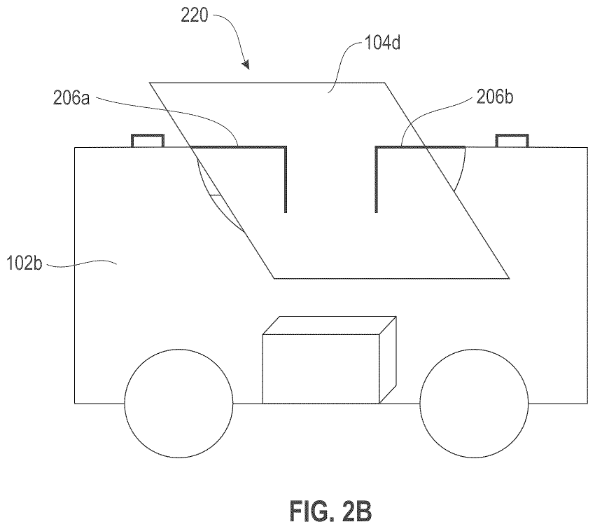

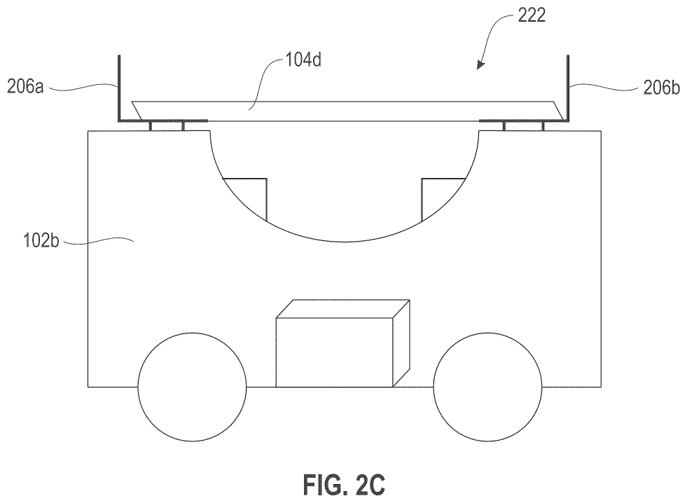

FIG. 1A shows a first automated guided vehicle 102a fulfilling a material transport assignment by transporting a first material 104a along a first transport path 124a from a first pickup location 120a to a first drop-off location 122a. At the first pickup location 120a, the first material 104a may be loaded onto and secured to the first automated guided vehicle 102a for transport. At the first drop-off location 122a, the first material 104a may be removed or unloaded from the first automated guided vehicle 102a. Other machines and/or workers may be involved in the loading and unloading. The respective vehicle such as the first automated guided vehicle 102a may have several stowage positions able to receive and hold material for transport. FIGS. 2a, 2b, and 2c which are described subsequently show multiple stowage positions for an automated guided vehicle. The material movement plan may include instructions as to how the material should be loaded onto or placed on the transport vehicle such as the automated guided vehicle.

FIG. 1A shows the industrial floor environment 100a in a crowded state, with one or more human workers being stationed next to each of the machines respectively. These workers protrude at least partially into a potential navigation space for the first automated guided vehicle 102a. In order to avoid a collision of the first automated guided vehicle 102a with any of the human workers or with any of the machines, a first path space 112a having a reduced size and width is set up for the material movement plan in this instance. The controller 114 may receive various input variables about the configuration of the crowded industrial floor environment 100a and the components disposed therein and on that basis recognize that due to the crowded nature the first path space 112a should be narrow. The controller 114 may establish first path boundaries 110a for the AGV path and may generate and transmit navigation instructions to the first automated guided vehicle 102a. These navigation instructions instruct the first automated guided vehicle 102a to remain within the first path boundaries 110a while the environment is in the crowded state. The first automated guided vehicle 102a may move from left to right in the shown embodiment to transport the first material 104a from the first pickup location 120a (that is towards the left in the view of FIG. 1A) to the first drop-off location 122a (that is towards the right in the view of FIG. 1A).

FIG. 1A shows an extended machine arm 116a attached to or near one of the machines. In this embodiment, the extended machine arm 116a being in its extended state provides some protection for the human worker next to the associated machine. When the machine arm is in an extended state as depicted in FIG. 1A, the machine may have a machine extended space 132c which is a larger space than when the protective arm is folded. If an automated guided vehicle were to approach this machine in a manner which would endanger the human worker, the extended machine arm 116a may block the automated guided vehicle and thereby protect the human worker. Although FIG. 1A depicts a single machine arm for the various machines, each machine may include one or more such protective arms and/or other protective structure. For example, each machine may include a front protective arm and a rear protective arm which together enclose a protected space for a human worker working at the respective machine. Thus, the configuration of two rows of machines depicted in FIG. 1A may have a total of sixteen protective arms, eight protective arms, or some other number of protective arms.

A controller 114 is shown in the working environment 100 which may sense and/or determine which structures are in the crowded industrial floor environment 100a, their positions, shapes, and/or dimensions, the positions, shapes, and dimensions of any automated guided vehicles such as the first automated guided vehicle 102a in the crowded industrial floor environment 100a, the material transport tasks of the automated guided vehicles in the crowded industrial floor environment 100a, the dimensions, shapes, and/or other physical characteristics of the material to be transported such as the first material 104a, and the pickup and drop-off locations for materials. The controller 114 may have a camera and/or one or more other sensors to determine the presence of automated guided vehicles and their positions in the crowded industrial floor environment 100a. The sensors may include active and/or passive sonar sensors. The controller 114 may receive data and other signals and may itself process the information to help generate a material movement plan or may transmit the data to one or more further computers for the other computers to generate a material movement plan. The variables may be received as notifications that are transmitted by other computers and received by the controller 114. The notifications may be transmitted in separate transmissions or in a combined transmission. The notifications may for example include a first notification, a second notification, a third notification, a fourth notification, and a fifth notification. The controller 114 may identify a transport task of the first automated guided vehicle 102a in the crowded industrial floor environment 100a including the need to transport the first material 104a from a first point, e.g., a pickup location, to a second point, e.g., a drop-off location. The controller 114 may sense that the machines such as the first machine 106a have human workers such as the first human worker 108a next to them so that a transport path for the first automated guided vehicle between a first row of the machines and a second row of the machines should be narrow.

The controller 114 may receive and/or calculate a first machine space requirement 132a that includes extra space for the human workers. The controller 114 may receive and/or calculate a first transport space requirement 134a that encompasses the space needed for the automated guided vehicle and the material that is being transported by the automated guided vehicle in a particular stowage position. The controller 114 may use the shape and dimensions of the automated guided vehicle, shapes and dimensions of the material to be transported, and the possible stowage positions for the material to be loaded onto the automated guided vehicle in order to determine the first transport space requirement 134a. This determination may include mathematical calculations that determines the widest aspect of the loaded vehicle. The controller 114 may generate the material movement plan so that the automated guided vehicles and

The material movement plan may also include the determination of the location and size of the first transport path 124a so that the first automated guided vehicle 102a is guided in the path to take between starting and ending. A first hindrance 126 such as a wall, gutter, and/or other structure may block a path beyond the first row 118a of the machines. A second hindrance 128 such as another wall, gutter, and/or other structure may block a path beyond the second row 118b of the machines. Due to these hindrances, the controller 114 may generate a material movement plan that includes the first transport path 124a passing between the first row 118a of machines and the second row 118b of machines.

The controller 114 may generate and transmit to the first automated guided vehicle 102a a material movement plan for the first automated guided vehicle 102a to receive and transport the first material 104a. This plan may include the first automated guided vehicle 102a staying within the first path boundaries 110a so as to avoid collision with a human worker and to avoid collision with any of the machines. In this crowded industrial floor environment 100a, a single automated guided vehicle, namely the first automated guided vehicle 102a, is in this instance along the first transport path 124a between the first row 118a and the second row 118b of the machines. The first automated guided vehicle 102a may operate and move according to the received material movement plan that was transmitted by the controller 114. The controller 114 and/or another computer with a material movement planning program 310a, 310b may also control a transport speed of the first automated guided vehicle 102a to help achieve safe and fast material movement of the first material 104a. The controller may assign the first material 104a to be held with a longitudinal axis of the first material 104a running parallel to or colinear with the longitudinal axis of the first automated guided vehicle 102a.

Referring to FIG. 1B, an open industrial floor environment 100b in accordance with an exemplary embodiment is depicted. The machines shown in FIG. 1B are those machines shown in FIG. 1A including the two rows—the first row 118a and the second row 118b. In this instance, however, the human workers are not next to the machines. For example, the first machine 106a like in FIG. 1A is positioned second in the first row 118a but in the instance depicted in FIG. 1B the first human worker 108a has vacated the area next to the first machine 106a. Thus, more space is available between the two rows for material transport via automated guided vehicles. The controller 114 has received input about reduced space requirements for the machines, e.g., a second machine space requirement 132b which indicates that the space needed for a particular machine is reduced as compared to the space needed in the configurations shown in FIG. 1A. Therefore, the controller 114 has generated a material movement plan which allows for a second transport space requirement 134b which is wider as compared to the needed AGV+material space in the FIG. 1A configuration. Specifically, the automated guided vehicles such as the first automated guided vehicle 102a may hold a second material 104b with an opposite orientation as compared to the orientation of the first material 104a shown in FIG. 1A. The second material 104b is held with its longitudinal axis running transverse to the longitudinal axis of the first automated guided vehicle 102a. Also due to the less-crowded nature of the open industrial floor environment 100b shown in FIG. 1B, multiple automated guided vehicles are transporting respective materials according to this iteration of the material movement plan generated by the controller 114.

The material movement plan may also include the determination of the location and size of the second transport path 124b so that the first automated guided vehicle 102a is guided in the path to take between starting and ending. In the depicted embodiment, the material movement plan included placing the second transport path 124b between the first row 118a of machines and the second row 118b of machines in order for the automated guided vehicles to transport materials from the second pickup location 120b to the second drop-off location 122b.

The controller 114 may receive various notifications about variables and generate and transmit to the first automated guided vehicle 102a another material movement plan for the first automated guided vehicle 102a to receive and transport the second material 104b based on the variables. The controller may determine the material movement plan itself or pass the variables to a further computer which holds a machine learning model for determining this additional material movement plan. This plan may include the first automated guided vehicle 102a staying within the second path space 112b so as to avoid collision with any of the machines. Because the human workers are not present, the second path space 112b may be wider and larger as compared to the first path space 112a that was shown for the material movement plan carried out in FIG. 1A. In this open industrial floor environment 100b, the generated material movement plan may include multiple automated guided vehicles simultaneously transporting respective materials along the second transport path 124b. The first automated guided vehicle 102a may operate and move according to the received material movement plan that was transmitted by the controller 114. The controller 114 and/or another computer with a material movement planning program 310a, 310b may also control a transport speed of the various automated guided vehicles to help achieve safe and fast material movement of the materials such as the second material 104b and the longer material 104c. The controller may assign the second material 104b to be held with a longitudinal axis of the second material 104b running transverse and/or perpendicular to the longitudinal axis of the first automated guided vehicle 102a.

In the open industrial floor environment 100b shown in FIG. 1B, the second path space 112b is larger than the first path space 112a shown in FIG. 1A. Thus, the path available for the automated guided vehicles with their stowed materials is larger and expanded. The automated guided vehicles may safely stay within the new boundaries without contacting and/or colliding with the surrounding machines and without contacting and/or colliding human workers (which are not present in this area at this time).

FIG. 1A shows a folded machine arm 116b. This folded machine arm 116b is the same arm as the extended machine arm 116a shown in FIG. 1A but with the arm in a folded state. As part of the material movement plan generated by the controller 114, an instruction signal may be transmitted to the machine. The instruction signal commands the machine to fold the machine arm into the configuration for the folded machine arm 116b. This folding allows additional space to be available for the automated guided vehicles and their material movement. With its protective arm in the folded configuration, the machine has a machine folded space 132d which is smaller than the machine extended space 132c depicted in FIG. 1A. By entering the folded configuration, the machine reduces its outward extension. The controller 114 may calculate that one or more of the automated guided vehicles with a transverse-loaded material may strike the protective arm and may on the basis of that determination generate and transmit the fold instruction to the machine.

FIG. 1B shows an embodiment with a transport group 136 of multiple automated guided vehicles working together to transport a single unusually-sized material, in this instance the longer material 104c. This example shows three automated guided vehicles in the transport group 136, but in other embodiments other numbers of automated guided vehicles may be in a single transport group for transporting a single material together. For example, two automated guided vehicles may work together in a single transport group to carry a single material. In another example, four automated guided vehicles may work together in a single transport group to carry a single material. The machine learning model may recognize the need for such a transport group 136 based upon input variables about the size, dimensions, and/or physical characteristics of the material to be transported and about the securing components of the automated guided vehicles. For example, variables about the large length/size dimensions of the long material 104c may cause the machine learning model to output the request for the transport group 136. The controller 114 may determine whether the dimensions of the material exceed a maximum size allowance for goods on the first vehicle. In response to determining that the dimensions exceed the maximum size allowance, the controller 114 may automatically select at least one second vehicle for transporting the first material with the first vehicle along the transport path. The first vehicle and any other selected vehicle may together support a material during transport. The material movement plan may also be generated by taking into account turning radiuses of the automated guided vehicles with the material loaded thereon. For any curved portion of the generated transport path, a turning radius may be calculated to ensure that significant passing room is available between the machines for the automated guided vehicles and the loaded materials to safely pass without collision. The turning radius may take into account the positioning of the loaded material during the turn. For a transport task with a transport group 136, the turning radius is increased so that additional passing space is necessary at the curved portion. For example, the transport group 136 shown in FIG. 1B may take a wider (e.g., a less-sharp) turn when exiting the space between the first row 118a and the second row 118b of machines than is depicted with the dotted lines of the second transport path 124b. The first automated guided vehicle 102a itself in FIG. 1B may take a wider (e.g., a less-sharp) turn than is depicted with the dotted lines of the second transport path 124b. The sharp turn is shown for simplicity purposes of fitting the path onto the page.

In some embodiments, the bendability of the material to be transported may be a factor taken into account by the machine learning model to determine whether a transport group 136 is necessary for the transport task. A long material with low bendability may in some instances be successfully transported with a single automated guided vehicle. A long material with moderate or high bendability may require a transport group 136 because if such material were transported by a single automated guided vehicle undesirable bending of the long material 104c may occur due to torque generated at the unsupported ends of the long material 104c.

It should be appreciated that FIGS. 1A and 1B provide illustrations of some implementations and do not imply any limitations with regard to the environments in which the material movement planning system and method may be implemented. Many modifications to the depicted environments and structures may be made based on design and implementation requirements.

FIG. 2A illustrates a side view of an automated guided vehicle used according to some embodiments to receive and transport a material according to a generated material movement plan. FIG. 2A shows a second automated guided vehicle 102b and a fourth material 104d to be transported in a transport task. The fourth material 104d includes a length 202 and a width 204 which may be taken into account by the machine learning model to generate the loading plan and transport plan as part of the material movement plan. The second automated guided vehicle 102b may include a vehicle controller 214 which may communicate with the controller 114 for receiving instructions. In other embodiments, the vehicle controller 214 may itself host a machine learning model and receive variables and generate a material movement plan based on the received variables. The second automated guided vehicle 102b may include a central concave opening and a first platform 208a and a second platform 208b within the central concave opening. The second automated guided vehicle may be laterally open into the central concave opening so that a material may be set onto the first and the second platforms 208a, 208b for stowage and transport. Thus, as is labeled in FIG. 2B the first and the second platforms 208a, 208b may be part of a first stowage position 220 for transporting a material. FIG. 2A also shows that the second automated guided vehicle 102b may include a first pivotable arm 206a and a second pivotable arm 206b which as is shown in FIG. 2B may help secure the loaded material that is in the first stowage position 220.

FIG. 2B illustrates the side view of the first automated guided vehicle 102b shown in FIG. 2A, but with the fourth material 104d now having been loaded in the first stowage position 220. according to at least one embodiment. FIG. 2B shows that in this embodiment the first pivotable arm 206a and the second pivotable arm 206b have been pivoted from their initial positions shown in FIG. 2A so as to rest on and press with a securing force against the fourth material 104d which is resting on the first and the second platforms 208a, 208b. The machine learning model may generate a securing instruction to activate securing structures such as the pivotable arms based on a size and physical characteristics of the material to be transported, e.g., based on a predicted need to prevent sliding and undesired dismounting of the transported material from the respective automated guided vehicle.

With this fourth material 104d secured in the first stowage position 220 as depicted in FIG. 2B, this embodiment includes the longitudinal axis of the fourth material 104d being transverse and/or perpendicular to a longitudinal axis of the second automated guided vehicle 102b. Thus, with the loading and stowage position shown in FIG. 2B the second automated guided vehicle 102b may be suited for transport in the open industrial floor environment 100b shown in FIG. 1B which has the second path space 112b larger in size due to no human workers being present at the machines and due to foldable machine extensions being folded.

FIG. 2C illustrates the side view of the second automated guided vehicle 102b shown in FIG. 2A with the fourth material 104d having been loaded according to an embodiment in a second stowage position 222. The fourth material 104d rests on the first pivotable arm 206a and on the second pivotable arm 206b when these first and second pivotable arms 206a, 206b are in the non-pivoted position shown in FIG. 2A.

With this fourth material 104d being in the second stowage position 222 as depicted in FIG. 2C, this embodiment includes the longitudinal axis of the fourth material 104d being parallel to or colinear with a longitudinal axis of the second automated guided vehicle 102b. Thus, with the loading and stowage position shown in FIG. 2C the second automated guided vehicle 102b may be suited for transport in the crowded industrial floor environment 100a shown in FIG. 1A which has a first path space 112a narrow in size. With the loading and stowage position shown in FIG. 2C the second automated guided vehicle 102b may also be suited for transport in the open industrial floor environment 100b shown in FIG. 1B which has the second path space 112b larger in size.

It should be appreciated that FIGS. 2A-2C provide illustrations of some implementations and do not imply any limitations with regard to the automated guided vehicles with which different embodiments may be implemented. Many modifications to the depicted automated guided vehicles may be made based on design and implementation requirements.

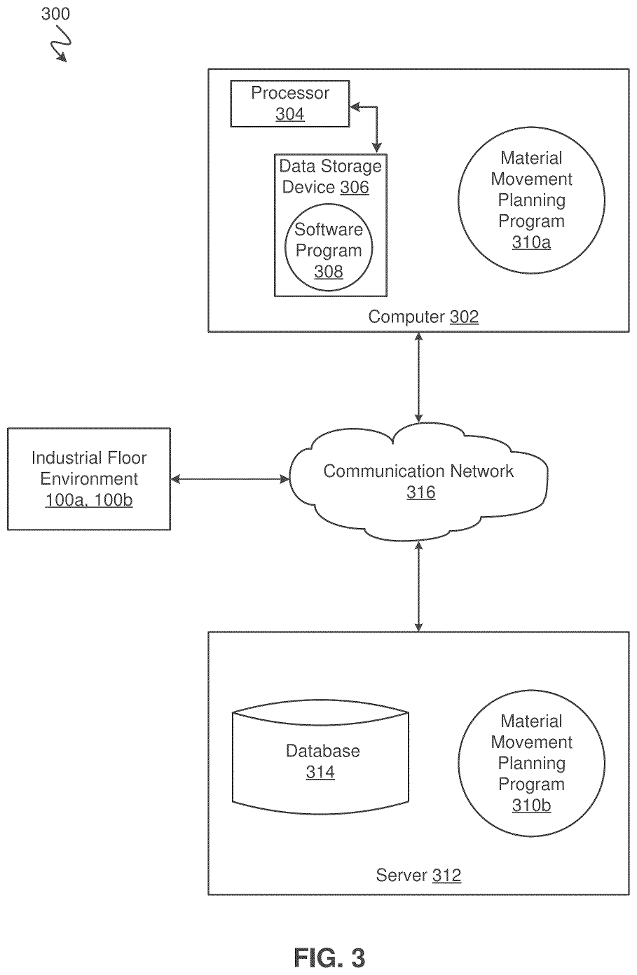

Referring to FIG. 3, an exemplary networked computer environment 300 in accordance with one embodiment is depicted and which may include the industrial floor environments 100a, 100b that are depicted in FIGS. 1A and 1B. The networked computer environment 300 may include a computer 302 with a processor 304 and a data storage device 306 that is enabled to run a software program 308 and a material movement planning program 310a. The networked computer environment 300 may also include a server 312 that is a computer and that is enabled to run a material movement planning program 310b that may interact with a database 314 and a communication network 316. The server 312 may include a plurality of machine learning modules and/or may use the communication network 316 to access other servers which host machine learning models. The networked computer environment 300 may include a plurality of computers 302 and servers 312, although only one computer 302 and one server 312 are shown in FIG. 3. The communication network 316 allowing communication between the computer 302 and the server 312 may include various types of communication networks, such as the Internet, a wide area network (WAN), a local area network (LAN), a telecommunication network, a wireless network, a public switched telephone network (PTSN) and/or a satellite network.

It should be appreciated that FIG. 3 provides only an illustration of one implementation and does not imply any limitations with regard to the environments in which different embodiments may be implemented. Many modifications to the depicted environments may be made based on design and implementation requirements.

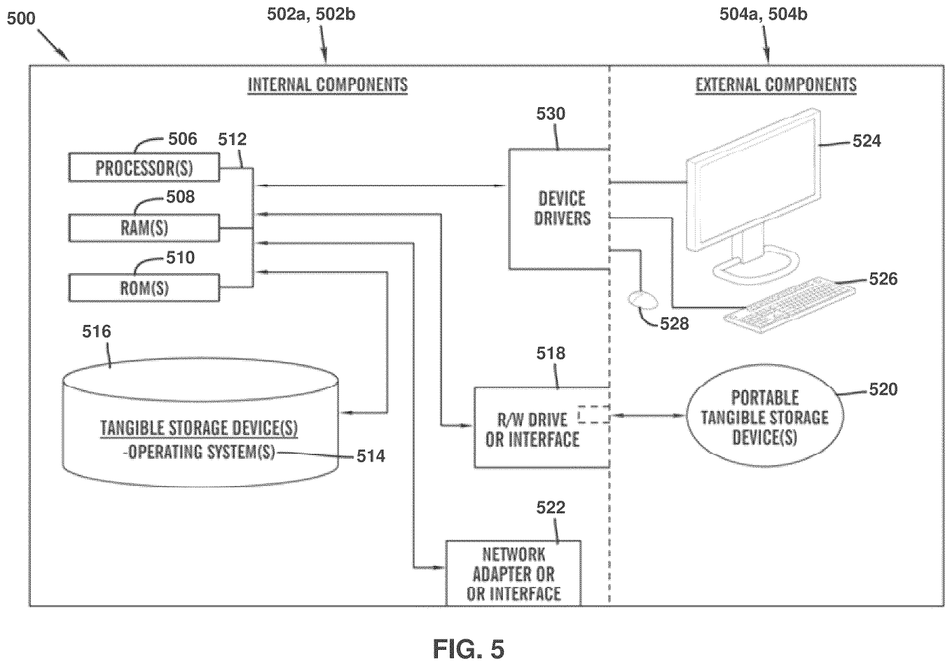

The computer 302 may communicate with the server 312 via the communication network 316. Individual robots and/or automated guided vehicles within the industrial floor environments 100a, 100b and having an individual control computer such as the vehicle controller 214 may also communicate with the client computer 302 and/or the server 312 via the communication network 316. The communication network 316 may include connections such as wire, wireless communication links, and/or fiber optic cables. As will be discussed with reference to FIG. 5, server 312 may include internal components 502a and external components 504a, respectively, and computer 302 may include internal components 502b and external components 504b, respectively. Server 312 may also operate in a cloud computing service model, such as Software as a Service (SaaS), Platform as a Service (PaaS), or Infrastructure as a Service (IaaS). Server 312 may also be located in a cloud computing deployment model, such as a private cloud, community cloud, public cloud, or hybrid cloud. Computer 302 may be, for example, a mobile device, a telephone, a personal digital assistant, a netbook, a laptop computer, a tablet computer, a desktop computer, or any type of computing devices capable of running a program, accessing a network, and accessing a database 314 in a server 312 that is remotely located with respect to the computer 302. The computer 302 may be mobile and may include a display screen and a camera. According to various implementations of the present embodiment, the material movement planning program 310a, 310b may interact with a database 314 that may be embedded in various storage devices, such as, but not limited to a computer/mobile device 302, a networked server 312, or a cloud storage service.

As will be discussed with reference to FIG. 5, the server 312 may include internal components 502a and external components 504a, respectively. The computer 302, the controller 114, and interior computers of the various automated guided vehicles and workpiece machines of the industrial floor environments 100a, 100b shown in FIGS. 1A and 1B such as the vehicle controller 214 may also each include internal components 502b and external components 504b as depicted in FIG. 5. Server 312 may also operate in a cloud computing service model, such as Software as a Service (SaaS), Platform as a Service (PaaS), or Infrastructure as a Service (IaaS). Server 312 may also be located in a cloud computing deployment model, such as a private cloud, community cloud, public cloud, or hybrid cloud. The computer 302 and the controller 114 may be, for example, a mobile device, a telephone, a personal digital assistant, a netbook, a laptop computer, a tablet computer, a desktop computer, or any type of computing devices capable of running a program, accessing a network, and accessing a database 314 in a server 312 that is remotely located with respect to the computer 302 or the controller 114. The computer 302, the controller 114, and computers of the automated guided vehicles and/or other robots may each include a display screen, a speaker, a microphone, a camera, and a keyboard or other input device for receiving output and providing input to the respective computer. According to various implementations of the present embodiment, the material movement planning program 310a, 310b may interact with a database 314 that may be embedded in various storage devices, such as, but not limited to a various computers/mobile devices, a server 312 that may be in a network, or another cloud storage service. The controller 114 and the vehicle controller 214 may also include an instance of the material movement planning program for generating a loading and transport plan for transporting a workpiece on an automated guided vehicle through the industrial floor environment 100a, 110b.

The material movement planning program 310a, 310b may be used to generate a material movement plan based on various warehouse inputs that are received. The material movement planning program 310a, 310b may then transmit the movement plan to receiver components of computers that are on-board the automated guided vehicles (“AGVs”), machines, or other components to carry out loading, transport, and unloading of the materials. In some embodiments, the AGVs and/or the machines will host a central computer which generates the material movement plan and then communicates instructions to receivers of computers on the AGVs, machines, loading/unloading structures, and other warehouse structures. Thus, in this embodiment such central computer on the AGV or machine such as the vehicle controller 214 may replace or supplement the controller 114.

The material movement planning program 310a, 310b may also generate and transmit a material movement plan, plan execution progress updates, and approval messages to be transmitted to another computer for review and/or approval of an administrator and/or manager of the industrial floor environment 100a, 100b e.g., of a warehouse. In some embodiments, the material movement planning program 310a, 310b may require approval from an administrator before authorizing the AGVs to carry out material loading and transport to try a technique, orientation, or position of material which has not previously been completed and/or attempted at this facility. For example, a material movement plan generated at the controller 114, at an AGV computer of the first AGV 102a, and/or at the server 312 may be sent via the communication network 316 to a manager at the computer 302 for approval of the material movement plan. A machine learning model may determine whether the material movement plan constitutes a new or previously unused configuration that should be reviewed by a manager. If the machine learning model outputs that the proposed material movement plan exceeds a threshold of uniqueness, the material movement planning program 310a, 310b may in an automated manner generate and transmit a message to an administrator to request authorization to implement the proposed material movement plan.

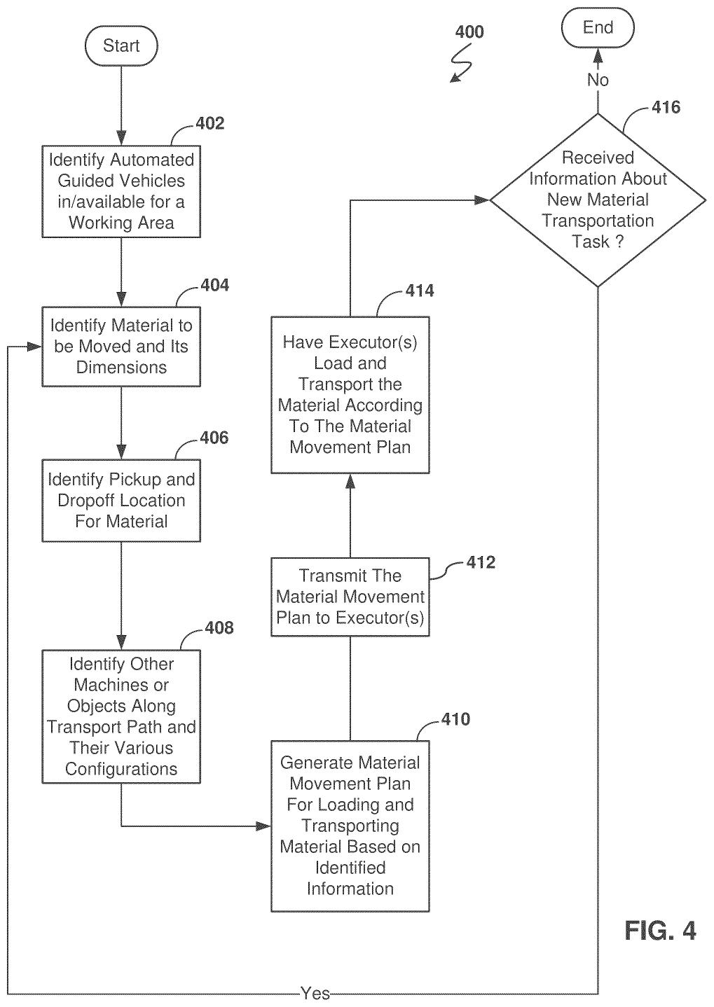

Referring now to FIG. 4, an operational flowchart depicts a material movement planning process 400 that may, according to at least one embodiment, be performed using the material movement planning program 310a, 310b. The various components and the automated guided vehicles such as the first automated guided vehicle 102a in the industrial floor environments 100a, 100b shown in FIGS. 1A and 1B may be involved in executing the material movement plan that is generated in the material movement planning process 400. The material movement planning program 310a, 310b may include various modules, user interfaces, and services, and may use data storage when the material movement planning process 400 is performed.

In a step 402 of the material movement planning process 400, automated guided vehicles that are in and/or available for a working area are identified. The working area may include a warehouse, a factory that has one or more assembly lines and/or stations, a machine shopfloor, and/or an industrial floor. The crowded industrial floor environment 100a shown in FIG. 1A and the open industrial floor environment 100b shown in FIG. 1B are examples of a working area for step 402. The automated guided vehicles may include the first automated guided vehicle 102a shown in FIG. 1A, the six automated guided vehicles shown in FIG. 1B, and the second automated guided vehicle 102b shown in FIGS. 2A, 2B, and 2C. The identification of step 402 may occur via a controller 114 in the vicinity of the working area as is shown in FIGS. 1A and 1B. The controller 114 may include one or more sensors such as a camera in order to identify automated guided vehicles in the working area. The controller 114 may also include an AGV database which may manually be updated by a manager of the working area in order to input information indicating the automated guided vehicles that are available for usage at the respective working area, e.g., in the industrial floor environment 100a, 100b. The automated guided vehicles may respectively include a global navigational signal responder which generates a global navigational signal which may be sensed by a global navigational signal receiver at the controller 114. The controller 114 may include a passive and/or active sonar sensor to recognize the presence of automated guided vehicles in the working environment.

The identification of step 402 may alternatively or additionally be achieved by receiving information via a user uploading the information into a computer such as the computer 302. The information may be uploaded at another computer and transmitted via the communication network 316 to the computer 302, to the controller 114, and/or to one of the automated guided vehicles and/or work area machines.

In some embodiments, one or more robots may maneuver around the industrial floor environment 100a, 100b and use an attached scanner and/or camera and/or sonar sensor to gather the information about the working environment and automated guided vehicles within the working environment as a part of step 402.

The identification of step 402 may include identifying the current position and possible stowage positions of the one or more automated guided vehicles. The positions may be identified by analyzing one or more sensor signals that are received in step 402 to identify the presence of the automated guided vehicles. The controller 114 may be able to sense a position of the respective automated guided vehicle, obtain and use a dimensional design plan of the particular automated guided vehicle which may provide information about various material stowage positions of the automated guided vehicle, and determine if any of the material stowage positions is currently occupied. Thus, the identification may include identifying if any of the automated guided vehicles is already currently undertaking a material transport assignment/task. Step 402 may also include a sensor such as a camera or a global navigational signal receiver identifying stowage positions of the automated guided vehicles and any material already loaded onto the automated guided vehicle at one of those storage positions. Database information about a design of an automated guided vehicle may be saved and accessed to determine which stowage positions that a respective automated guided vehicle offers.

In a step 404 of the material movement planning process 400, a material to be moved and the dimensions of that material to be moved are identified. The first material 104a shown in FIG. 1A, the second material 104b shown in FIG. 1B, the longer material 104c shown in FIG. 1B, and the fourth material 104d shown in FIGS. 2A, 2B, and 2C are examples of materials that may be identified in step 404. In the embodiment shown in FIG. 1B, step 404 may include identifying that three materials having the same dimensions are ready for transport. These three materials may include the second material 104b. The identification of step 404 may occur via the controller 114 in the vicinity of the working area. One or more sensors such as the camera of the controller 114 may sense data in order to identify materials to be transported and their dimensions. The controller 114 may also include a material database which may manually be updated by a manager of the working area in order to input the materials that need to be transported in the respective working area, e.g., in the industrial floor environment 100a, 100b. In some embodiments, the materials to be transported may respectively include a global navigational signal responder which generates a global navigational signal which may be sensed by a global navigational signal receiver at the controller 114. The controller 114 may include a passive and/or active sonar sensor to recognize the presence of materials to be transported in the working environment.

The identification of step 404 may alternatively or additionally be achieved by receiving information via a user uploading the material information into a computer such as the computer 302. The information may be uploaded at another computer and transmitted via the communication network 316 to the computer 302, to the controller 114, and/or to one of the automated guided vehicles and/or work area machines.

In some embodiments, one or more robots may maneuver around the industrial floor environment 100a, 100b and use an attached scanner and/or camera and/or sonar sensor to gather the information about the materials to be transported within the working environment as a part of step 404.

The identification of step 404 may include identifying the dimensions of the material. For example, the identification may include determining that a length of the longer material 104c is greater than the length of the first material 104a and of the second material 104b. The controller 114 may be able to sense a type of the material, obtain and use a dimensional design plan of the particular material which may provide information about a shape and dimensions of the material.

The identification of step 404 may include identifying additional physical characteristics of the one or more materials to be transported. For example, the identification may include determining a bendability and/or a fragility of the material to be transported. This information may be received via manual upload and/or via active gathering via sensors such as a sonar sensor.

In a step 406 of the material movement planning process 400, a pickup location and a drop-off location for the material are identified. The material may be that material identified in step 404. This information may be received in step 406 by a user uploading the information into a computer such as the computer 302. The information may be uploaded at another computer and transmitted via the communication network 316 to the computer 302, to the controller 114, and/or to one of the automated guided vehicles, working area machines, and/or industrial robots. This information may also be received by capturing sensor signals about other movements occurring at or near the working area, such as delivery vehicles arriving at a working area. The pickup location and drop-off location may be input into a machine learning model that as output generates one or more possible transport paths for delivering the material from the pickup location to the drop-off location. The machine learning model may be hosted at the controller 114, at the material movement planning program 310a in the computer 302, in the material movement planning program 310b in the server 312, and/or in some other remote server or computer. In one example, a transport path that is output by the machine learning model includes a path with a minimum distance between the pickup and drop-off locations. The first pickup location 120a and the first drop-off location 122a shown in FIG. 1A are examples of the locations that may be identified in step 406. The second pickup location 120b and the second drop-off location 122b shown in FIG. 1B are additional examples of the locations that may be identified in step 406.

In a step 408 of the material movement planning process 400, other machines and/or objects along the transport path and their various configurations are identified. The first row 118a and the second row 118b of machines including the first machine 106a may be some of the machines that are identified in step 408. Step 408 may include determining current and/or scheduled configurations of the various machines. For example, when the machines are currently or scheduled to have their first machine space requirement 132a as shown in FIG. 1A which includes extra space for human workers this configuration may be sensed and/or received. Information about a workspace schedule for the various machines may be received. When the machines are currently or scheduled to have their second machine space requirement 132b which as shown in FIG. 1B needs no extra space for human workers, this configuration may be sensed and/or received.

The identification of step 408 may occur via the controller 114 in the vicinity of the working area. One or more sensors such as the camera of the controller 114 may sense data in order to identify machines and objects along the transport path, their dimensions, and possible configurations. The controller 114 may also include a machine database which may manually be updated by a manager of the working area in order to input the machines, their dimensions, and possible configurations in the respective working area, e.g., in the industrial floor environment 100a, 100b. In some embodiments, the machines may respectively include a global navigational signal responder which generates a global navigational signal which may be sensed by a global navigational signal receiver at the controller 114. The controller 114 may include a passive and/or active sonar sensor to recognize the presence of machines in the working environment.

The identification of step 408 may alternatively or additionally be achieved by receiving information via a user uploading the material information into a computer such as the computer 302. The information may be uploaded at another computer and transmitted via the communication network 316 to the computer 302, to the controller 114, and/or to one of the automated guided vehicles and/or work area machines.

In some embodiments, one or more robots may maneuver around the industrial floor environment 100a, 100b and use an attached scanner and/or camera and/or sonar sensor to gather the information about the machines within the working environment as a part of step 408.

The identification of step 408 may include identifying the dimensions and various configurations of the machines including whether human workers are currently disposed at or next to the machines. For example, in the instance shown in FIG. 1A, the controller 114 may determine via sensor such as via one or more cameras and/or microphones that a respective human worker such as the first human worker 108a is next to each of these eight machines in the two rows of four machines. In the instance shown in FIG. 1B, the controller 114 may determine via sensor that none of the eight machines in the two rows of four machines has a respective human worker stationed thereby. The identification of step 408 may include determining whether any of the machines includes protruding elements that may be folded and/or otherwise reduced in size for differing configurations. For example, the identification of step 408 may include determining that at least one of the machines includes the foldable arm which may have an extended configuration 116a shown in FIG. 1A and a folded configuration 116b shown in FIG. 1B. In the folded configuration 116b, the arm has reduced an outward extension of the machine. The controller 114 may be able to sense a type of the machine and obtain and use a dimensional design plan of the particular machine which may provide information about dimensions and configurations of the machine. Step 408 may include determining which activities are currently being undertaken at the machines in the warehouse.

In a step 410 of the material movement planning process 400, a material movement plan for loading and transporting the material is generated based on the identified information. The identified information may include the information identified in all and/or some of the steps 402, 404, 406, and 408 described above. A machine learning model may be used to generate a material movement plan for safely and quickly transporting a material from the pickup location to the drop-off location on one or more of the available automated guided vehicles. The machine learning model may be trained with supervised training which inputs various scenarios of various sets of inputs and suitable and optimal material movement plans based on those input sets. The machine learning model may be disposed in the controller 114, in the material movement planning program 310a of the computer 302, in the material movement planning program 310b of the server 312, in the vehicle controller 214, and/or in another computer or server in another location that is accessible via the communication network 316.

The material movement plan may include a total distance of the transport path and a transport speed for the selected one or more automated guided vehicles. The material movement plan may include a loading technique for reducing harm to the material and/or for reducing a generated noise during loading onto the automated guided vehicle. When less space is available along the potential transport paths, for example as is shown in the FIG. 1A embodiment, then for safety purposes the machine learning model may generate a plan which includes fewer automated guided vehicles engaging in material transport at the same time in the same area as part of the material movement plan. When more space is available along the potential transport paths, for example as is shown in the FIG. 1B embodiment, the machine learning model may generate a plan which includes more automated guided vehicles being engaged in material transport at the same time in the same area as part of the material movement plan. The material movement planning program 310a, 310b may also use mathematical calculations as part of the machine learning model for designing the material movement plan.

The material movement plan may be generated to update paths for multiple automated guided vehicles within the working environment. The plan in this embodiment may allow the automated guided vehicles to arrive at a drop-off location at a staggered time plan so that wait times for the automated guided vehicles at the drop-off location may be reduced or eliminated and so that unloading equipment may be free to unload the material when the automated guided vehicle arrives at the drop-off location. Similar principles may be applied for staggering arrival of the automated guided vehicles at the material pickup location. The machine learning model may be able to generate a complex alignment plan which helps the one or more robots achieve a complex task, e.g., a complex product assembly.

In a step 412 of the material movement planning process 400, the material movement plan is transmitted to one or more executors. This material movement plan that is transmitted in step 412 may be the material movement plan that was generated in step 410. The one or more executors may include the automated guided vehicles such as the first automated guided vehicle 102a shown in FIGS. 1A and 1B, the transport group 136 shown in FIG. 1B, and the second automated guided vehicle 102b shown in FIGS. 2A-2C. This transmission of step 412 may occur to multiple executors such as to multiple automated guided vehicles and to machines in the working environment. The executor may be another computer within the warehouse so that a warehouse worker can read the instructions to be prepared for manually moving away from the transport path and/or to help with material loading and/or unloading with respect to the automated guided vehicle. The executors may also include the machines themselves, for example, when the material movement plan includes a fold instruction for folding a foldable element of the machines such as the foldable arm 116a in order to create more transport space for the automated guided vehicles.

For those embodiments where a control computer with one of the automated guided vehicles generates the material movement plan, this transmission may occur within the automated guided vehicle, e.g., along a bus connecting computer components within the automated guided vehicle or via wireless transmission between such components. This transmission may also be from the interior control computer of the automated guided vehicle to one or more other computers within the same automated guided vehicle for powering and directing the automated guided vehicle, e.g., the wheels of the automated guided vehicle, to carry out a transport task as part of the material movement plan instructions. When multiple automated guided vehicles are to be involved in the material movement planning process 400, a lead automated guided vehicle with a control computer may transmit the instructions in a message via the communication network 316 to the one or more other automated guided vehicles.

In a step 414 of the material movement planning process 400, the one or more executors load and transport the material according to the material movement plan. The one or more executors that perform the transport task may be the executor that received the material movement plan in step 412. In at least some embodiments, the one or more executors includes an automated guided vehicle. Other work area machines and human workers may also be included as part of the one or more workers. A machine may execute a fold instruction as part of step 414 in some embodiments.

In a step 416 of the material movement planning process 400, a determination is made whether information is received about a new material transportation task. If the determination of step 416 is affirmative that information is received about a new material transportation task, the material movement planning process 400 returns to step 404 to repeat steps 404, 406, 408, 410, 412, and 414 for the new transport task. If the determination of step 416 is negative and no information is received about a new material transportation task, the material movement planning process 400 may end.

Any machine learning model used for various steps of the material movement planning process 400 may include naive Bayes models, random decision tree models, linear statistical query models, logistic regression n models, neural network models, e.g. convolutional neural networks, multi-layer perceptrons, residual networks, long short-term memory architectures, algorithms, deep learning models, and other models. The one or more machine learning models may be trained. The process of training a machine learning model may include providing training data to a learning algorithm or to a machine learning algorithm. The machine learning model is the model structure or system that is created by the training process. The training data should include targets or target attributes which include a correct answer. Training data for the present embodiments may include similar information for other warehouses and/or facilities and appropriate material movement plans that were generated for transporting goods in those other working environments. The learning algorithm finds patterns in the training data in order to map the input data attributes to the target. The machine learning model contains these patterns so that the answer can be predicted for similar future inputs. A machine learning model may be used to obtain predictions on new data for which the target is unknown. The machine learning model uses the patterns that are identified to determine what the target is for new data without a given answer. Training may include supervised and/or unsupervised learning.

Various commercial platforms exist to allow a machine learning model to be created or trained. The training may include selecting data types, uploading data, selecting class types, and allowing a commercial system to then train the data. Such data upload may occur at the computer 302 or at another computer associated with the server 312. The machine learning model that is generated may be stored on computer 302 or on the server 312 or on another external server accessible to the computer 302 and to the server 312 via the communication network 316. The automated design of the material movement plan for the automated guided vehicles may be performed via a machine learning model on the device or in the cloud. Using a machine learning model on the device, e.g., on a computer that is within one of the automated guided vehicles such as on the vehicle controller 214 or such as on the controller 114, helps reduce data transmission required between the device, the automated guided vehicles, and a server in the cloud. Such a mobile machine learning model may be performed using inference-based machine learning models such as TensorFlow® Lite (TensorFlow® and all TensorFlow®—based trademarks and logos are trademarks or registered trademarks of Google, Inc. and/or its affiliates).

The material movement planning process 400 may be implemented for a working environment which includes multiple conveyors and/or tracks. The material movement plan generated may account for the location and paths of other tracks in the working environment.

In some embodiments, a material movement plan may occur on the basis of the controller 114 sensing that some malfunction or break has occurred and that another automated guided vehicle or machine is blocking a shortest path between pickup and drop-off locations. The material movement plan in this embodiment may generate an alternate route for the automated guided vehicle to travel to the drop-off location.

In some embodiments, the controller 114 may as part of an update alter a travel path of an automated guided vehicle based on the needs of the automated guided vehicles. For example, if an automated guided vehicle needs to be refueled or recharged the transport path may include traveling by a refueling or recharging station so that the vehicle does not run out of power along the way of performing the transport task.

The transport path may be modified on the fly if a drop-off position is changed on short notice and this change is transmitted to the controller 114. The controller 114 may then submit an updated set of information into the machine learning model to produce as output a revised material movement plan. The updates may be transmitted from the controller 114 to the involved automated guided vehicles to notify them of a new modified transport path.

The material movement planning program 310a, 310b may identify the contextual scenario in the machine shopfloor. The contextual scenario may include what types of activities are being performed at different machines, the space required by the machines while performing the activities, and human worker movement for the machines and for performing any other tasks in the working area. The material movement planning program 310a, 310b may accordingly identify appropriate timing of the material movement by one or more of the AGVs so that material movement by the AGVs does not disturb the working area ecosystem.

While the material is being moved on the industrial floor, either with one or more automated guided vehicles or manually driven vehicles, the material movement planning program 310a, 310b may identify surrounding machines or robotic systems that have extended components such as arms. The material movement planning program 310a, 310b may command those extended components to retract, e.g., may command the extended arm to fold, into a smaller configuration to allow sufficient clearance for material movement performed with the one or more AGVs. FIGS. 1A and 1B show with the foldable arm 116 an example of these retraction features for expanding the transport area for the AGVs and for reducing the required space of the machines.

The material movement planning program 310a, 310b may take into consideration noise generation, movement aspects, and timing concerns such as transport duration when generating the material movement plan for transporting one or more materials from pickup to drop-off locations associated with the working environment with minimal or no disturbance to the working area ecosystem. Respective noise amounts to be produced via loading the first material onto the first vehicle at each of the stowage positions may be determined via, for example, the controller 114 and the machine learning model. The generating the material movement plan may in some embodiments include the controller 114 and the machine learning model selecting the stowage position further based on generating a smallest noise amount during the loading of the first material.

The material movement planning program 310a, 310b may take into consideration a type of the material to be moved such as whether the material is a solid material, a fluid material is held in a container, and/or is a gas material held in a container. A weight of the material may also be taken into consideration in generating the material movement plan and for determining whether a transport group such as the transport group 136 shown in FIG. 1B is necessary for transporting the material. A single AGV may have a weight transport limit that may be exceeded by some material to be carried. Two or more AGVs working together may have a combined weight transport limit that exceeds the weight of the item to be carried. Whether the material is hazardous, has any sharp protruding elements, and has any other safety requirements for handling may also be taken into consideration by the machine learning model as to how the material should be loaded, unloaded, and transported on the one or more AGVs with minimal or no disturbance in the working area ecosystem.

The material movement planning program 310a, 310b may implement digital twin simulation to simulate the one or more AGVs, the transported material, and the environment to identify any movement and/or vibration on the material during transport. The material movement plan may choose an alternative to reduce or eliminate material vibration during the loading, transport, and unloading. The digital twin simulation may include a digital twin model for each and every AGV identified in step 302. The digital twin simulation may include a digital twin for each machine such as the first machine 106a in the working area. The machines may be performing metal cutting activities. A notification of vibration qualities of a material to be transported may be received. The generating the material movement plan performed, for example, via the controller 114 and the machine learning model may include (1) predicting vibration of the first material during transport in a selected stowage position on the first vehicle, (2) determining whether the predicted vibration exceeds a maximum safety force for the first material, and (3) in response to determining that the predicted vibration exceeds the maximum safety force, selecting another stowage position that reduces the predicted vibration.

The material movement planning program 310a, 310b may take into account a position of a center of gravity of the material to be transported in selecting a stowage position and AGV type for the material movement plan. The drop-off location may also be referred to as a target location. The pickup location may also be referred to as a source location.

When generating the material movement plan, the material movement planning program 310a, 310b and the associated machine learning model may take into account the schedule of different working area activities and time required to complete the different activities. The material movement planning program 310a, 310b may identify if the machines need additional safety space in the surrounding work area. Based on historically gathered information about required safety while activity was performed with the machines, based on manual feed of the machines and/or AGV loading, based on simulated information, and based on current working area configurations, the material movement planning program 310a, 310b may identify how much space is required around the machines and, thereby, how much space is available for the AGV transport.

The material movement planning program 310a, 310b may identify how many material movement passages/lanes (and their respective sizes) are to be reserved to meet required safety factors with one or more machines while the machines are operating. The material movement planning program 310a, 310b will calculate the space available for material movement by the AGV. The material movement planning program 310a, 310b may identify the completion time of the activities of the machines in the industrial floor. The material movement planning program 310a, 310b may identify the dimensions and specification of the materials to be moved from one location to another location. Based on the identified available space for a material movement path, the material movement planning program 310a, 310b will simulate how the material are to be moved through the material movement passage, will predict any problems for a proposed plan, refine the plan if necessary, and then transmit the plan for execution by the one or more executors.

The material movement planning program 310a, 310b may, for example, consider human movement parameters, activities with the surrounding machines, and material dimensions to determine how the materials are to be moved. The material movement planning program 310a, 310b may identify if a manual material movement vehicle should be used alone or along with an AGV to perform a transport task.

In the machine shopfloor, based on the activities with the machines and required safety passage for movement of human workers, the material movement planning program 310a, 310b will identify the appropriate timing for material movement. Based on digital simulated result of the AGV, the material movement planning program 310a, 310b will identify if the materials to be moved will vibrate. Based on this determination, the material movement planning program 310a, 310b may decide if multiple AGVs are required for material movement.

It may be appreciated that FIG. 4 provides an illustration of some embodiments and does not imply any limitations with regard to how different embodiments may be implemented. Many modifications to the depicted embodiment(s), e.g., to a depicted sequence of steps, may be made based on design and implementation requirements. Steps and features from the various processes may be combined into the other processes that are described in other drawings or embodiments.

FIG. 5 is a block diagram 500 of internal and external components of computers depicted in FIGS. 1A-1B, 2A-2C, and 3 in accordance with an illustrative embodiment of the present invention. It should be appreciated that FIG. 5 provides only an illustration of one implementation and does not imply any limitations with regard to the environments in which different embodiments may be implemented. Many modifications to the depicted environments may be made based on design and implementation requirements.

Data processing system 502a, 502b, 504a, 504b is representative of any electronic device capable of executing machine-readable program instructions. Data processing system 502a, 502b, 504a, 504b may be representative of a smart phone, a computer system, PDA, or other electronic devices. Examples of computing systems, environments, and/or configurations that may represented by data processing system 502a, 502b, 504a, 504b include, but are not limited to, personal computer systems, server computer systems, thin clients, thick clients, hand-held or laptop devices, multiprocessor systems, microprocessor-based systems, network PCs, minicomputer systems, and distributed cloud computing environments that include any of the above systems or devices.

The computer 302, the server 312, the controller 114, and any other computer of the various automated guided vehicles in the industrial floor environments 100a, 100b may include respective sets of internal components 502a, 502b and/or external components 504a, 504b illustrated in FIG. 5. Each of the sets of internal components 502a, 502b includes one or more processors 506, one or more computer-readable RAMs 508 and one or more computer-readable ROMs 510 on one or more buses 512, and one or more operating systems 514 and one or more computer-readable tangible storage devices 516. The one or more operating systems 514, the software program 308 in the computer 302, the material movement program 310a in the computer 302, and the material movement program 310b in server 312 may be stored on one or more computer-readable tangible storage devices 516 for execution by one or more processors 506 via one or more RAMs 508 (which typically include cache memory). In the embodiment illustrated in FIG. 5, each of the computer-readable tangible storage devices 516 is a magnetic disk storage device of an internal hard drive. Alternatively, each of the computer-readable tangible storage devices 516 is a semiconductor storage device such as ROM 510, EPROM, flash memory, or any other computer-readable tangible storage device that can store a computer program and digital information.

Each set of internal components 502a, 502b also includes a RAY drive or interface 518 to read from and write to one or more portable computer-readable tangible storage devices 520 such as a CD-ROM, DVD, memory stick, magnetic tape, magnetic disk, optical disk or semiconductor storage device. A software program, such as the software program 308 and the material movement planning program 310a, 310b can be stored on one or more of the respective portable computer-readable tangible storage devices 520, read via the respective R/W drive or interface 518 and loaded into the respective hard drive, e.g., the tangible storage device 516.

Each set of internal components 502a, 502b may also include network adapters (or switch port cards) or interfaces 522 such as a TCP/IP adapter cards, wireless wi-fi interface cards, or 3G, 4G, or 5G wireless interface cards or other wired or wireless communication links. The software program 308 and the material movement planning program 310a in the computer 302 and/or in one of the automated guided vehicles or controller 114 and the material movement planning program 310b in the server 312 can be downloaded from an external computer (e.g., server) via a network (for example, the Internet, a local area network or other, wide area network) and respective network adapters or interfaces 522. From the network adapters (or switch port adaptors) or interfaces 522, the software program 308 and the material movement planning program 310a in the computer 302 and the material movement planning program 310b in server 312 are loaded into the respective hard drive, e.g., the tangible storage device 516. The network may include copper wires, optical fibers, wireless transmission, routers, firewalls, switches, gateway computers and/or edge servers.

Each of the sets of external components 504a, 504b can include a computer display monitor 524, a keyboard 526, and a computer mouse 528. External components 504a, 504b can also include touch screens, virtual keyboards, touch pads, pointing devices, and other human interface devices. Each of the sets of internal components 502a, 502b also includes device drivers 530 to interface to computer display monitor 524, keyboard 526 and computer mouse 528. The device drivers 530, RAY drive or interface 518 and network adapter or interface 522 include hardware and software (stored in storage device 516 and/or ROM 510).

The present invention may be a system, a method, and/or a computer program product at any possible technical detail level of integration. The computer program product may include a computer readable storage medium (or media) having computer readable program instructions thereon for causing a processor to carry out aspects of the present invention

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It is understood that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

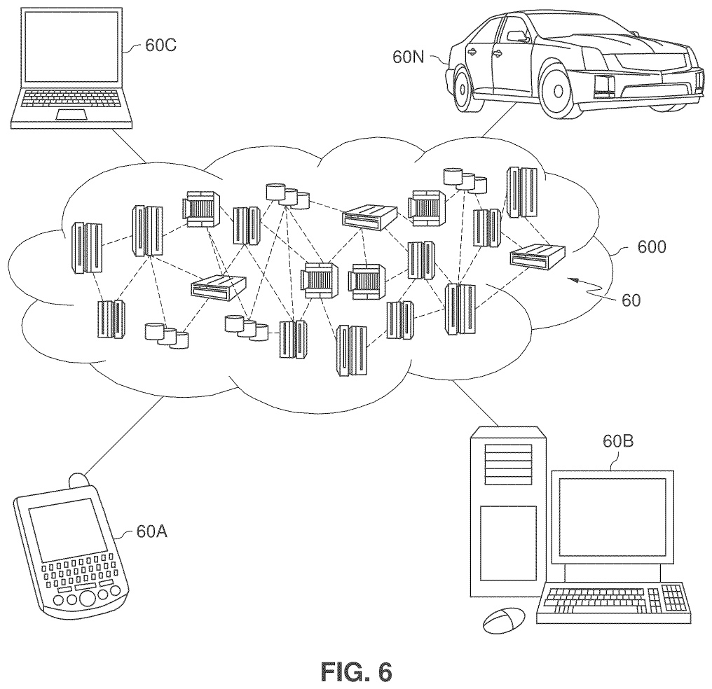

Referring now to FIG. 6, illustrative cloud computing environment 600 is depicted. As shown, cloud computing environment 600 comprises one or more cloud computing nodes 60 with which local computing devices used by cloud consumers, such as, for example, personal digital assistant (PDA) or cellular telephone 60A, desktop computer 60B, laptop computer 60C, and/or automobile computer system 60N may communicate. Nodes 60 may communicate with one another and may include computers of automated guided vehicles and industrial floor control computers such as are shown in FIGS. 1A, 1B, 2A, 2B, 2C, and 3. They may be grouped (not shown) physically or virtually, in one or more networks, such as Private, Community, Public, or Hybrid clouds as described hereinabove, or a combination thereof. This allows cloud computing environment 600 to offer infrastructure, platforms and/or software as services for which a cloud consumer does not need to maintain resources on a local computing device. It is understood that the types of computing devices 60A-N shown in FIG. 6 are intended to be illustrative only and that computing nodes 60 and cloud computing environment 600 can communicate with any type of computerized device over any type of network and/or network addressable connection (e.g., using a web browser).

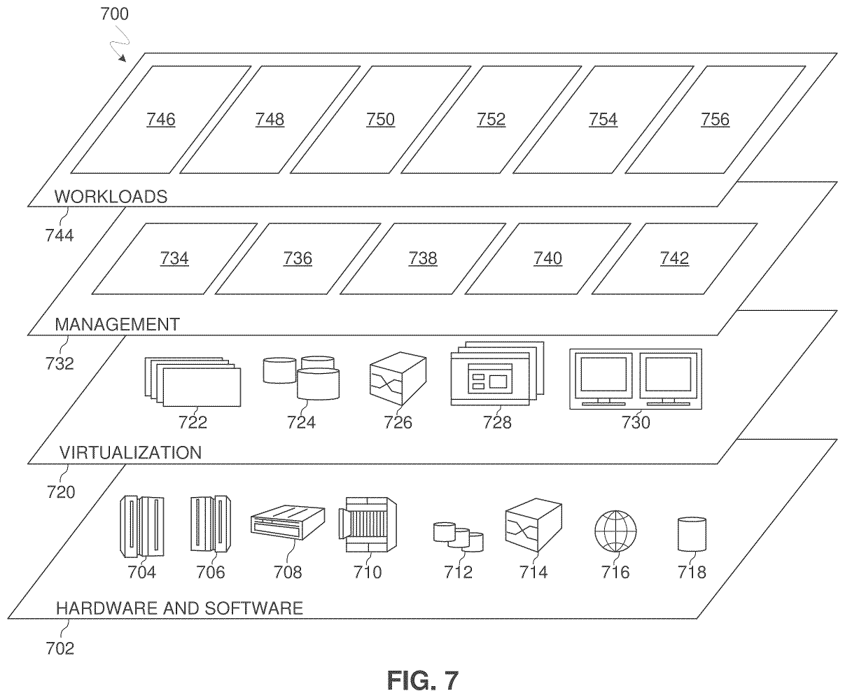

Referring now to FIG. 7, a set of functional abstraction layers 700 provided by cloud computing environment 600 is shown. It should be understood in advance that the components, layers, and functions shown in FIG. 7 are intended to be illustrative only and embodiments of the invention are not limited thereto. As depicted, the following layers and corresponding functions are provided:

Hardware and software layer 702 includes hardware and software components. Examples of hardware components include: mainframes 704; RISC (Reduced Instruction Set Computer) architecture based servers 706; servers 708; blade servers 710; storage devices 712; and networks and networking components 714. In some embodiments, software components include network application server software 716 and database software 718.

Virtualization layer 720 provides an abstraction layer from which the following examples of virtual entities may be provided: virtual servers 722; virtual storage 724; virtual networks 726, including virtual private networks; virtual applications and operating systems 728; and virtual clients 730.

In one example, management layer 732 may provide the functions described below. Resource provisioning 734 provides dynamic procurement of computing resources and other resources that are utilized to perform tasks within the cloud computing environment. Metering and Pricing 736 provide cost tracking as resources are utilized within the cloud computing environment, and billing or invoicing for consumption of these resources. In one example, these resources may comprise application software licenses. Security provides identity verification for cloud consumers and tasks, as well as protection for data and other resources. User portal 738 provides access to the cloud computing environment for consumers and system administrators. Service level management 740 provides cloud computing resource allocation and management such that required service levels are met. Service Level Agreement (SLA) planning and fulfillment 742 provide pre-arrangement for, and procurement of, cloud computing resources for which a future requirement is anticipated in accordance with an SLA.

Workloads layer 744 provides examples of functionality for which the cloud computing environment may be utilized. Examples of workloads and functions which may be provided from this layer include: mapping and navigation 746; software development and lifecycle management 748; virtual classroom education delivery 750; data analytics processing 752; transaction processing 754; and material movement planning 756. A material movement program 310a, 310b provides a way to automate loading and transport planning of workpieces by automated guided vehicles in an industrial floor.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises,” “comprising,” “includes,” “including,” “has,” “have,” “having,” “with,” and the like, when used in this specification, specify the presence of stated features, integers, steps, operations, elements, and/or components, but does not preclude the presence or addition of one or more other features, integers, steps, operations, elements, components, and/or groups thereof.

The descriptions of the various embodiments of the present invention have been presented for purposes of illustration but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for material movement planning, the method comprising:
receiving, via a computer, a first notification of dimensions of a first material to be transported, a second notification of stowage positions of a first vehicle, a third notification of a pickup location and a drop-off location for the first material, and a fourth notification of space requirements of machines along a transport path;
generating, via the computer, a material movement plan for stowing the first material on the first vehicle and for transporting the first material along the transport path, the material movement plan being based on the dimensions of the first material, the stowage positions of the first vehicle, the transport path, and the space requirements for the machines; and
transmitting, via the computer, the material movement plan for loading the first material into one of the stowage positions on the first vehicle according to the material movement plan.

2. The method of claim 1, wherein the generating the material movement plan comprises:
determining, via the computer, whether a transport space requirement exceeds any path spaces along the transport path; and
in response to determining that the transport space requirement exceeds at least one path space along the transport path, selecting the stowage position that has a smaller transport space requirement for the first material.

3. The method of claim 1, wherein:
the fourth notification includes an extra space requirement for a human worker positioned at a first machine along the transport path, and
the material movement plan positions the first material on the first vehicle so as not to engage the extra space requirement for the human worker.

4. The method of claim 1, wherein the generating the material movement plan comprises:
determining, via the computer, whether the first material will engage in a space of a first machine along the transport path; and
in response to determining that the first material will engage in the space of the first machine, transmitting, via the computer, a fold instruction to the first machine so that the first machine reduces outward extension.

5. The method of claim 1, wherein the generating the material movement plan comprises:
determining, via the computer, whether the dimensions of the first material exceed a maximum size allowance for goods on the first vehicle; and
in response to determining that the dimensions exceed the maximum size allowance, selecting a second vehicle for transporting the first material with the first vehicle along the transport path, the first vehicle and the second vehicle together supporting the first material during transport.

6. The method of claim 1, further comprising receiving, via the computer, a fifth notification of vibration qualities of the first material to be transported;
wherein the generating the material movement plan comprises:
predicting, via the computer, vibration of the first material during transport in the stowage position on the first vehicle;
determining, via the computer, whether the predicted vibration exceeds a maximum safety force for the first material; and
in response to determining that the predicted vibration exceeds the maximum safety force, selecting another stowage position that reduces the predicted vibration.

7. The method of claim 6, wherein the other stowage position requires a second vehicle for supporting the first material together with the first vehicle during the transport.

8. The method of claim 1, further comprising determining, via the computer, respective noise amounts to be produced via loading the first material onto the first vehicle at each of the stowage positions;
wherein the generating the material movement plan comprises selecting, via the computer, the stowage position further based on generating a smallest noise amount during the loading of the first material.

9. A computer system for material movement planning, the computer system comprising:
one or more processors, one or more computer-readable memories, and program instructions stored on at least one of the one or more computer-readable memories for execution by at least one of the one or more processors to cause the computer system to:
receive a first notification of dimensions of a first material to be transported, a second notification of stowage positions of a first vehicle, a third notification of a pickup location and a drop-off location for the first material, and a fourth notification of space requirements of machines along a transport path;
generate a material movement plan for stowing the first material on the first vehicle and for transporting the material along the transport path, the material movement plan being based on the dimensions of the first material, the stowage positions of the first vehicle, the transport path, and the space requirements for the machines; and
transmit the material movement plan for loading the first material into one of the stowage positions on the first vehicle according to the material movement plan.

10. The computer system of claim 9, wherein the generating the material movement plan comprises:
determining, via the computer, whether a transport space requirement exceeds any path spaces along the transport path; and
in response to determining that the transport space requirement exceeds at least one path space along the transport path, selecting the stowage position that has a smaller transport space requirement for the first material.

11. The computer system of claim 9, wherein:
the fourth notification includes an extra space requirement for a human worker positioned at a first machine along the transport path, and
the material movement plan positions the first material on the first vehicle so as not to engage the extra space requirement for the human worker.

12. The computer system of claim 9, wherein the generating the material movement plan comprises:
determining, via the computer, whether the first material will engage in a space of a first machine along the path; and
in response to determining that the first material will engage in the space of the first machine, transmitting, via the computer, a fold instruction to the first machine so that the first machine reduces outward extension.

13. The computer system of claim 9, wherein the generating the material movement plan comprises:
determining, via the computer, whether the dimensions of the first material exceed a maximum size allowance for goods on the first vehicle;
in response to determining that the dimensions of the first material exceed the maximum size allowance, selecting a second vehicle for transporting the first material with the first vehicle along the transport path, the first vehicle and the second vehicle together supporting the first material during transport.

14. The computer system of claim 9, wherein the program instructions are further for execution to cause the computer system to receive a fifth notification of vibration qualities of the first material to be transported;
wherein the generating the material movement plan comprises:
predicting, via the computer, vibration of the first material during transport in the stowage position on the first vehicle;
determining, via the computer, whether the predicted vibration exceeds a maximum safety force for the first material; and
in response to determining that the predicted vibration exceeds the maximum safety force, selecting another stowage position that reduces the predicted vibration.

15. The computer system of claim 14, wherein the other stowage position requires a second vehicle for supporting the first material together with the first vehicle during the transport.

16. The computer system of claim 9, wherein the program instructions are further for execution to cause the computer system to determine respective noise amounts to be produced via loading the first material onto the first vehicle at each of the stowage positions;
wherein the generating the material movement plan comprises selecting, via the computer, the stowage position further based on generating a smallest noise amount during the loading of the first material.

17. A computer program product for material movement planning, the computer program product comprising a computer-readable storage medium having program instructions embodied therewith, the program instructions executable by a computer to cause the computer to:
receive a first notification of dimensions of a first material to be transported, a second notification of stowage positions of a first vehicle, a third notification of a pickup location and a drop-off location for the first material, and a fourth notification of space requirements of machines along a transport path;
generate a material movement plan for stowing the first material on the first vehicle and for transporting the first material along the transport path, the material movement plan being based on the dimensions of the first material, the stowage positions of the first vehicle, the transport path, and the space requirements for the machines; and
transmit the material movement plan for loading the first material into one of the stowage positions on the first vehicle according to the material movement plan.

18. The computer program product of claim 17, wherein the generating the material movement plan comprises:
determining, via the computer, whether a transport space requirement exceeds any path spaces along the transport path; and
in response to determining that the transport space requirement exceeds at least one path space along the transport path, selecting the stowage position that has a smaller transport space requirement for the first material.

19. The computer program product of claim 17, wherein:
the fourth notification includes an extra space requirement for a human worker positioned at a first machine along the transport path, and
the material movement plan positions the first material on the first vehicle so as not to engage the extra space requirement for the human worker.

20. The computer program product of claim 17, wherein the generating the material movement plan comprises:
determining, via the computer, whether the first material will engage in a space of a first machine along the path;
in response to determining that the first material will engage in the space of the first machine, transmitting, via the computer, a fold instruction to the first machine so that the first machine reduces outward extension.
